(19) United States
(12) Patent Application Publication
(10) Pub. No.: US 2012/0319911 A1
(43) Pub. Date: Dec. 20, 2012

(54) WIDE BANDWIDTH ANTENNA

(75) Inventor: CHIH-SHEN CHOU, MIAOLI COUNTY (TW)

(73) Assignee: UNICTRON TECHNOLOGIES CORPORATION, HSIN-CHU (TW)

(21) Appl. No.: 13/331,218

(22) Filed: Dec. 20, 2011

(30) Foreign Application Priority Data
Jun. 14, 2011 (TW) 100210757

(51) Int. Cl. H01Q 1/38; H01Q 1/36

(52) U.S. Cl. 343/787; 343/895

(57) ABSTRACT

A wide bandwidth antenna, wherein, at least an antenna module is provided on a substrate, said antenna module includes a plurality of antenna elements having spiral geometric patterns, that are connected one by one in series. Each antenna element is formed by an electrically conductive trace winding from outside said spiral geometric pattern to inside, then it winds back from inside to outside. A first antenna element in the antenna module is connected to a signal input terminal, and that is connected electrically to a signal transmission line.

### BACKGROUND OF THE INVENTION

1. Field of the Invention

The present invention relates to a wide bandwidth antenna, and in particular to a wide bandwidth antenna that utilizes a plurality of spiral geometric patterns to produce maximum coupled capacitance, in achieving a wide bandwidth for transmitting and receiving wireless signals.

2. The Prior Arts

With the advent of the age of digital information, various electronic products utilize digitalized design, even the conventional analog electronic devices are digitalized to achieve better performance. For example, the conventional analog TVs are gradually phased out of the market, and are replaced by digital TV. In general, digital TV uses Ultra High Frequency (UHF) or Very High Frequency (VHF) bands for program broadcasting. A wide bandwidth antenna is needed to receive digital TV broadcast. Normally, a symmetric and periodic structure is utilized to develop a wide bandwidth UHF or VHF antenna.

By way of example, a presently used wide bandwidth antenna structure of digital TV is taken as an example for explanation. Refer to FIG. 1 for a schematic diagram of a symmetric and periodic antenna structure according to the prior art. As shown in FIG. 1, the symmetric and periodic structure is of a planar butterfly type, including: a pair of symmetric first metal section 10, and a second metal section 12. Wherein, the first metal section 10 and the second metal section 12 extend and meander toward a signal input terminal 14 in a continuous and bending S-shape, with their respective terminals connected to a signal input terminal 14. In this structure, the angle and length of each bend of the metal section could define a resonant frequency bandwidth to meet the requirements of ¼ wavelength antenna. Along with the variations of the length of the metal section, the resonant frequency is changed, and the longer the metal section, the lower the resonant frequency; on the contrary, the shorter the metal section, the higher the resonant frequency. Therefore, the minimum length of the metal section determines the resonance point of the highest frequency, and the maximum length of the metal section determines the resonance point of the lowest frequency. So a wide bandwidth antenna thus formed has its resonance frequency bandwidth ranging from the highest frequency to the lowest frequency. Due to the design of the symmetric and periodic first metal section 10 and second metal section 12, they are capable of mutual impedance compensation, to determine the range of resonance frequency, hereby minimizing impedance variations and achieving optimal signal receiving quality.

Although, a wide bandwidth antenna can be realized through the antenna design mentioned above, yet an antenna thus designed requires large area, so its overall size tends to be enormously large. For example, for a UHF antenna of frequency range of from 470 MHz to 870 MHz made on a circuit board of dielectric constant of 4, and for the lowest frequency of 470 MHz, the width of a ¼ wavelength antenna could reach 8 cm. Presently, for the electronic product designs emphasizing light-weight, thin-profile, and compact-size, the size of antenna of this kind of design is still too large for practical applications, thus, it is not suitable for use in mobile electronic devices. Therefore, how to design a more miniaturized antenna having better signal receiving capability to meet the requirement of the present day electronic device is an important task, that has to be solved urgently in this field.

### SUMMARY OF THE INVENTION

In view of the problems and shortcomings of the prior art, the present invention discloses a wide bandwidth antenna, so as to solve and overcome problems and drawbacks of the prior art.

A major objective of the present invention is to provide a wide bandwidth antenna, such that an antenna of various geometric patterns is formed in a spiral approach, to have the advantages of varying operation frequency, increasing bandwidth, raising quality of transmission and receiving, and reduced size.

Another objective of the present invention is to provide a wide bandwidth antenna, that is simple in construction, easy to manufacture, thin in profile, and is suitable to use in various electronic devices, as such having a good competitive edge in the market.

To achieve the objective mentioned above, the present invention provides a wide bandwidth antenna, which is connected to at least one signal line for transmitting and receiving wireless signals, comprising: at least a substrate made of a dielectric material; at least a signal input terminal provided on the substrate for the establishment of electrical connection with the signal line for signal input and output; and at least an antenna module, disposed on the substrate, comprises a plurality of antenna elements with spiral geometric patterns, wherein the geometric pattern of the first antenna element is formed by an electrically conductive spiral trace winds from the starting point at the outside of the geometric pattern toward inside, and then winds back again from inside toward outside, and continuing from the end point of said geometric pattern of said first antenna element, the electrically conductive spiral trace of the second said antenna element winds from the outside of the geometric pattern toward inside, and then winds back from inside toward outside to form a second antenna element, continuing this process until the needed number of the antenna elements is established, the starting point of the spiral geometric pattern of the first antenna element is connected to the signal input terminal, and that is connected to a RF circuit to transmit and receive signals.

In the present invention, geometric pattern of the antenna element is of a round spiral shape, a square spiral shape, a triangle spiral shape, a polygon spiral shape, or an irregular spiral shape.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a symmetric and periodic antenna structure according to the prior art;

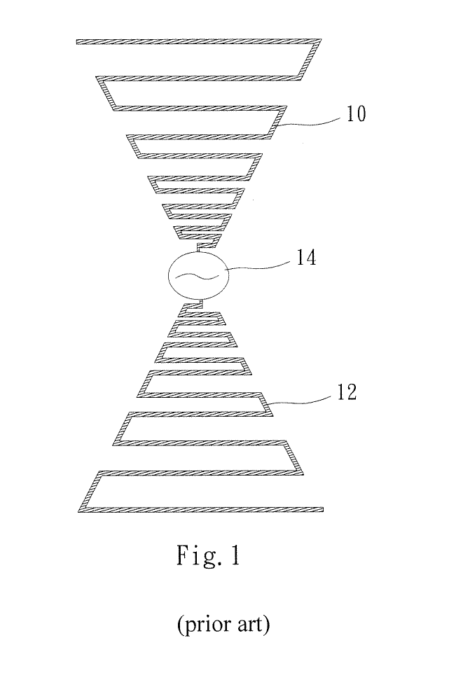

FIG. 2 is a schematic diagram of a wide bandwidth antenna according to a first embodiment of the present invention;

FIG. 3 is a schematic diagram of a wide bandwidth antenna according to a second embodiment of the present invention;

FIG. 4 is a schematic diagram of a wide bandwidth antenna according to a third embodiment of the present invention;

FIG. 5 is a schematic diagram of a wide bandwidth antenna according to a fourth embodiment of the present invention;

FIG. 6 is a schematic diagram of a wide bandwidth antenna according to a fifth embodiment of the present invention;

FIG. 7 is a schematic diagram of a wide bandwidth antenna according to a sixth embodiment of the present invention;

FIG. 8 is a schematic diagram of a wide bandwidth antenna according to a seventh embodiment of the present invention;

FIG. 9 is a graph of Voltage Standing Wave Ratio vs frequency according to the present invention;

FIG. 10 is a schematic diagram of a wide bandwidth antenna according to an eighth embodiment of the present invention;

FIG. 11 is a schematic diagram of a wide bandwidth antenna according to a ninth embodiment of the present invention;

FIG. 12 is a schematic diagram of a wide bandwidth antenna according to a tenth embodiment of the present invention;

FIG. 13 is a schematic diagram shows the installation of a wide bandwidth antenna on circuit board according to an eleventh embodiment of the present invention;

FIG. 14 is a schematic diagram shows the direct implementation on the circuit board of a wide bandwidth antenna according to a twelfth embodiment of the present invention; and

FIG. 15 is a schematic diagram shows the implementation on a multilayer circuit board of a wide bandwidth antenna according to a thirteenth embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

Due to the rapid progress and development of science and technology, various high-tech electronic products are developed for the convenience of our daily life, for example, various mobile devices, such as notebook computer, mobile phone, and PDA. Along with the popularization of these high-tech electronic products and demands of the market, in addition to various functions designed for these products, wireless communication capability is also provided. Therefore, the emphasis of design of high-tech electronic products is on light weight, thin profile, compact size, and system integration.

In this respect, mobile devices are taken as an example for explanation, and presently, the functions they provide are increasing, for example, viewing program of digital TV through a mobile device is an example of such an added function, to provide user with more diversified and convenient services. Therefore, the present invention provides a miniaturized wide bandwidth antenna having good wireless communication capability, that can be embedded in a mobile device, to provide convenience to the user.

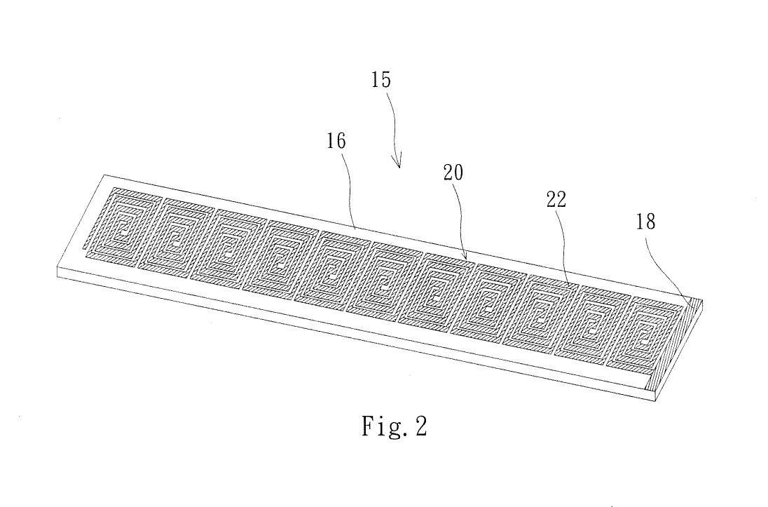

Refer to FIG. 2 for a schematic diagram of a wide bandwidth antenna according to a first embodiment of the present invention. As shown in FIG. 2, a wide bandwidth antenna 15, connected to at least one signal line for transmitting and receiving wireless signals, comprising: at least a substrate 16; a signal input terminal 18; and at least an antenna module 20. Wherein, the substrate 16 is made of dielectric material, which can be plastic, glass or ceramic, magnetic material, or a composite of the materials mentioned above. The signal input terminal 18 and antenna module 20 are made of electrically conductive materials, that can be made on substrate 16 through adhering, thick film, thin film, or plating process. The antenna module 20 includes a plurality of antenna elements 22 having spiral geometric patterns, each antenna element 22 is formed through utilizing a conduction trace to wind from the outside of the spiral geometric pattern toward inside, and then winds back from inside toward outside. Herein, an antenna element 22 of a square spiral geometric pattern is taken as an example for explanation. Wherein, the antenna elements 22 are connected one by one in such a way that, the conduction trace winds from outside of the spiral geometric pattern toward inside, and then winds back from inside toward outside, to form a first square spiral geometric pattern, that is to serve as the first antenna element 22 in the antenna module 20. Then, in the same approach, the end point of the conduction trace winding to outside of the first square-shape antenna element is used as the starting point to form the spiral geometric pattern of the next square-shape antenna element, to serve as the second antenna element 22 of the antenna module 20. Continue this process to generate a series of antenna elements 22 each having square-shape spiral geometric pattern connected one by one until the needed band width is achieved.

Wherein, the first antenna element 22 of the antenna module 20 defines the highest resonance frequency of the wide bandwidth antenna, while all the antenna elements 22 of the antenna module 20 jointly define the lowest resonance frequency, hereby realizing a wide bandwidth antenna having resonance frequency bandwidth ranging from the highest resonance frequency to the lowest resonance frequency. The first antenna element 22 of the antenna module 20 is connected to a signal input terminal 18, that is in turn connected electrically to a signal transmission line (for example, a coaxial cable). As such, an electronic device can be connected to the wide bandwidth antenna through the signal transmission line, to transmit and receive signals through the wide bandwidth antenna. Moreover, in the present invention, total number of the antenna elements and length of the antenna module determine the bandwidth of the wide bandwidth antenna, the bandwidth of the wide bandwidth antenna increases when total number of the antenna elements is increased or length of the antenna module is increased or both are increased.

From the above description, it can be known that, in order to meet the requirement of a wide bandwidth antenna, sufficient number of antenna elements are provided to obtain the bandwidth required. For example, it is able to meet the signal receiving requirement for UHF frequency band of Digital Video Broadcasting (DVB) for many parts of the world, with its bandwidth ranging from 470 MHz to 870 MHz. The wide bandwidth antenna of the present invention is able to meet all the bandwidth requirements mentioned above.

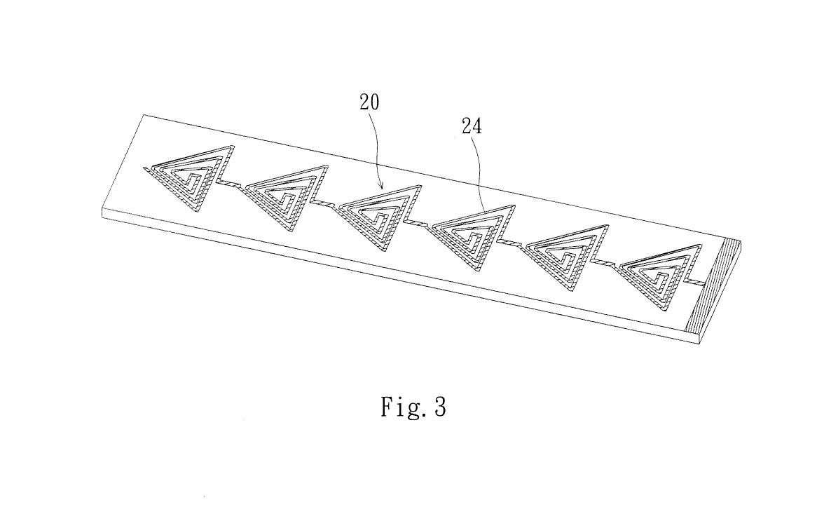

In the descriptions mentioned above, material of electrically conductive trace can be metal, alloy, such as copper or copper alloy, or other electrically conductive material. Segments of conduction traces can be considered as equivalent inductors, and adjacent segments of conduction traces can be considered as equivalent capacitors, so each of geometric patterns of antenna elements 22 can be considered as an equivalent circuit formed by a plurality of capacitors and inductors. As such, length of the spiral trace, width of the trace, spacing between the traces, number of loops of spiral and geometric shape of spiral determine the resonant frequency and the bandwidth of the antenna element 22 and the antenna module, namely it is equivalent to adjusting ratio of capacitance and inductance. Through this approach of design, coupling capacitance for each of the antenna elements 22 can be maximized to generate a wide bandwidth, hereby reducing effectively the overall size of the antenna. 100341 In addition to the above-mentioned antenna element 22 formed by the same square-shape spiral geometric patterns connected in series, refer to FIG. 3 for a schematic diagram of a wide bandwidth antenna according to a second embodiment of the present invention. As shown in FIG. 3, the antenna module 20 can be designed as formed by the same triangle-shape spiral geometric patterns of antenna elements 24 connected one by one in series.

In the second embodiment, the width of conduction trace and distance between conduction traces can be varied according to requirement, to adjust ratio of capacitance and inductance, the greater the ratio, the greater the coupling capacitance, thus realizing increased bandwidth.

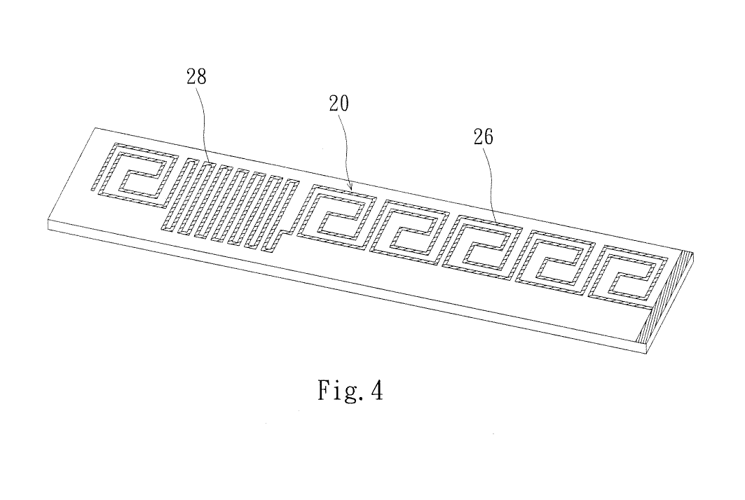

Then, refer to FIG. 4 for a schematic diagram of a wide bandwidth antenna according to a third embodiment of the present invention. As shown in FIG. 4, the antenna module 20 can be formed by mixing and connecting one by one a plurality of different geometric patterns of antenna elements. Herein, series connection of square-shape spiral geometric patterns and a meander trace segment are taken as example. In this example, a plurality of antenna elements 26 of the same square-shape spiral are connected in series, and in between the square-shape spiral geometric patterns, at least a meandering trace segment can be added, such as a plurality of segments of S-shape continuous and winding traces, to form a meandering antenna element 28. The trace segment can also be of other shapes such as a zigzag or other serpentine shape. Wherein, the distance between adjacent conduction traces and width of conduction trace in the geometric patterns of the square-shape spiral antenna element 26 or meandering antenna element 28 can be different. Therefore, length of meandering trace, number of turns, spacing and width of the trace can be adjusted depending on actual requirement, to obtain the resonance frequency required, in achieving a good antenna radiation pattern and quality of receiving

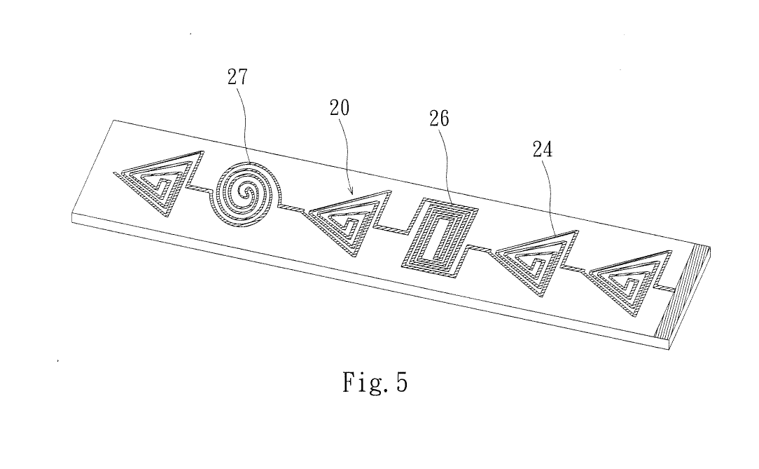

Then, refer to FIG. 5 for a schematic diagram of a wide bandwidth antenna according to a fourth embodiment of the present invention. As shown in FIG. 5, the antenna module 20 can be formed by mixing a plurality of antenna elements having different spiral geometric patterns. The difference between the fourth embodiment and the third embodiment is that, in the fourth embodiment, geometric patterns of triangle-shape spiral antenna element 24, square-shape spiral antenna element 26, and round-shape spiral antenna element 27 are connected together one by one in series. In this embodiment, geometric patterns of a plurality of triangle-shape spiral antenna elements 24 are connected in series, and in-between geometric patterns of at least a square-shape spiral antenna element 26, and at least a round-shape spiral antenna element 27 are added, to form an antenna module 20 connected in series,

Of course, in addition to the geometric patterns mentioned in the above embodiment for the antenna module 20, other geometric patterns can be used. For example, the geometric pattern of spiral antenna element could be wound in an ellipsis shape, in a polygon shape, or an irregular shape. Regardless the antenna module 20 formed by connecting the same spiral geometric pattern or different spiral geometric patterns together, as long as they can be used to adjust resonance frequency of antenna, they fall in the scope of the present invention. Therefore, the antenna module disposed on the dielectric substrate is formed by connecting the same geometric pattern of spirals or various geometric patterns of spirals.

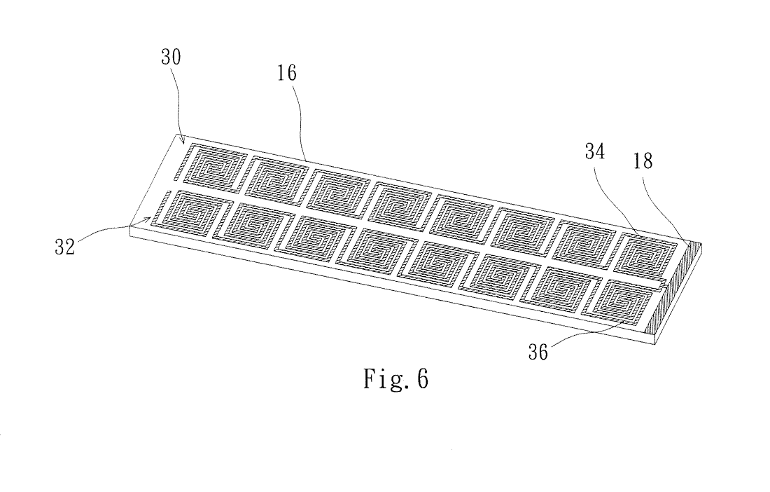

Subsequently, refer to FIG. 6 for a schematic diagram of a wide bandwidth antenna according to a fifth embodiment of the present invention. As shown in FIG. 6, a signal input terminal 18 and at least one antenna module are provided on a substrate 16, and herein, two antenna modules are taken as example for explanation, such that the first antenna module 30 includes geometric patterns of a plurality of spiral antenna elements 34, and the second antenna module 32 includes geometric patterns of a plurality of spiral antenna elements 36. Refer to the first embodiment for the connection and formation of the antenna elements. For example, after the conduction trace of the first of the antenna elements 34 of the first antenna module 30 is connected to the signal input terminal 18, the conduction trace starts to wind from the starting point at the outside of the spiral geometric pattern toward inside, and then winds back again from inside toward outside, to form a first spiral antenna element 34, starting from the end point of the conduction trace winding to outside of the first spiral antenna element, second antenna element can be formed in the same approach, continue this process, first antenna module 30 comprising a plurality of spiral geometric patterns connected one by one in series is formed. Likewise, the second antenna module 32 can be formed by connecting a plurality of antenna elements 36 one by one in series. It is worth to mention that, the first antenna elements in the antenna module 30, and the first antenna elements in the second antenna module 32 are connected in parallel, and then they are connected to the signal input terminal 18, hereby realizing a wide bandwidth antenna design, to meet the requirement of the market. In this embodiment, at least two antenna modules are established in parallel on the substrate, and the starting points of the first antenna elements of each antenna modules are connected together and then connected to the signal input terminal.

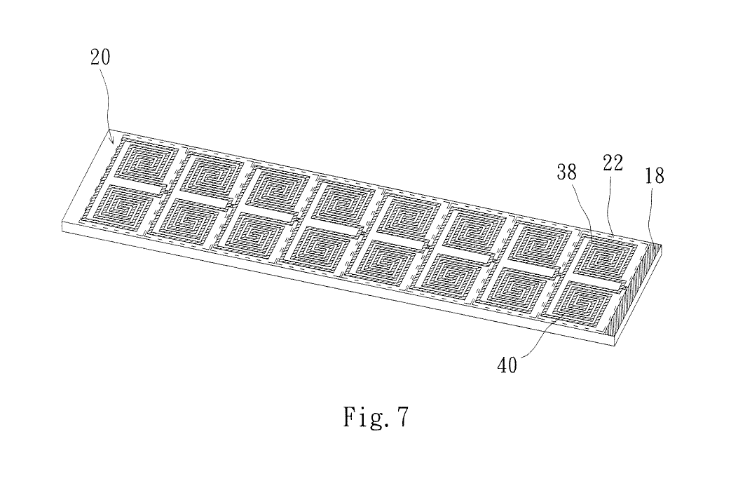

In addition to the fifth embodiment of wide bandwidth antenna wherein a plurality of antenna modules comprising serially connected spiral antenna elements are connected in parallel, refer to FIG. 7 for a schematic diagram of a wide bandwidth antenna according to a sixth embodiment of the present invention. As shown in FIG. 7, the antenna module 20 includes a plurality of antenna elements 22, with each antenna element 22 having a first sub-antenna element 38 and a second sub-antenna element 40 connected in parallel, and then the antenna elements 22 are connected in series in realizing the wide bandwidth antenna of the present embodiment. By way of example, the first sub-antenna element of the antenna element 22 uses conduction trace to wind from a starting point at the outside of the spiral geometric pattern toward inside, and then winds back again from inside toward outside, to form a spiral geometric pattern of a first sub-antenna element 38. The second sub-antenna element 40 can be formed in the same way. Then, the starting points of the conduction traces of the first sub-antenna element 38 and the second sub-antenna element 40 are connected to each other and the the end points of the conduction traces of the first sub-antenna element 38 and the second sub-antenna element 40 are connected to each other to form an antenna element comprising two sub-antenna elements connected in parallel. Then a plurality of antenna elements 22 are connected one by one in series and the first antenna element 22 are connected to the signal input terminal 18, hereby realizing a wide bandwidth antenna design wherein each antenna element comprises a plurality of parallelly connected sub-antenna elements and then a plurality of antenna elements are connected one by one in series. In this embodiment, each antenna element comprises at least two sub-antenna elements disposed in parallel on the substrate, and the starting points of each sub-antenna element in the same antenna element are connected together, and the end points of each sub-antenna element in the same antenna element are connected together, and the antenna elements are then connected one by one in series, and the starting point of the first antenna element is connected to the signal input terminal.

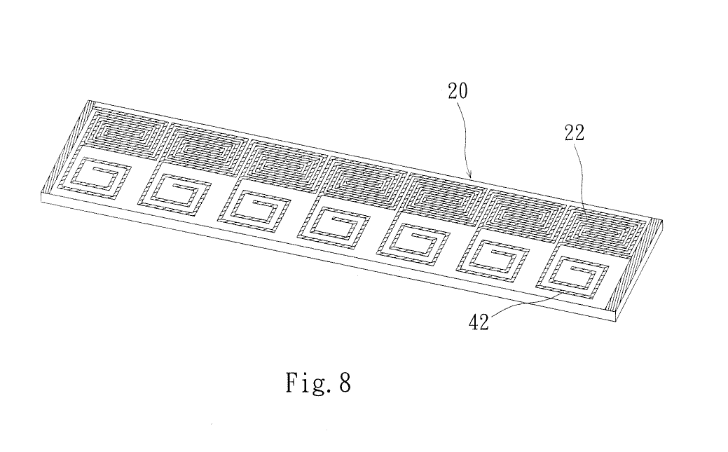

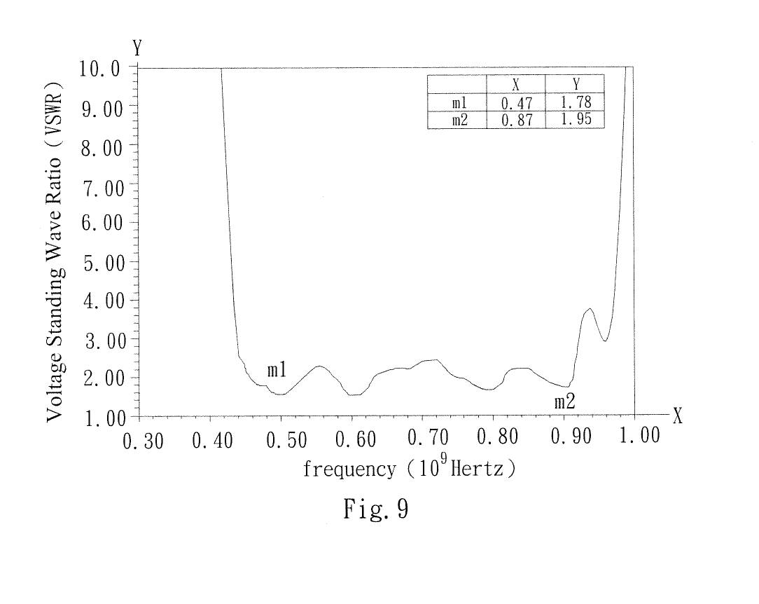

Then, refer to FIG. 8 for a schematic diagram of a wide bandwidth antenna according to a seventh embodiment of the present invention. The present embodiment is mostly the same as the first embodiment, thus that will not be repeated here for brevity. However, their difference is that, in the present embodiment, the antenna module 20 includes a plurality of antenna elements 22, each of them is selectively connected to a geometric pattern of a branch antenna element 42, to increase the bandwidth of resonance frequency of the antenna element, wherein the branch antenna element 42 comprises electrically conductive trace with various geometric pattern. Moreover, refer to FIG. 9 for a graph of Voltage Standing Wave Ratio (VSWR) vs frequency according to the present invention. As shown in FIG. 9 for the Voltage Standing Wave Ratio in the seventh embodiment, at 470 MHz, the VSWR value is 1.78, while at 870 MHz, the VSWR value is 1.95. From the VSWR curve of the wide bandwidth antenna of the seventh Embodiment, it can be known that, the wide bandwidth antenna of the present invention is able to meet the signal receiving requirement of DVB product in the 470-870 MHz frequency range.

In the present embodiment, the resonant frequency of the antenna element is decreased and the bandwidth at the resonant frequency of the antenna element is increased by adding a side branch to the geometric pattern of the antenna element. Furthermore, the geometric pattern of the side branch 42 is of a round spiral shape, a square spiral shape, a triangle spiral shape, a polygon spiral shape, an irregular spiral shape, a serpentine or meandering trace, or a trace segment of various shapes.

Since each antenna element 22 has a resonance frequency bandwidth, and that includes a range of resonance frequencies. However, frequently, due to influence of surrounding environment or impedance matching, VSWR value may be higher at certain frequency range. For example, in case the Voltage Standing Wave Ratio (VSWR) is greater than 3, then the signal receiving performance is not satisfactory. In order to improve this situation, a branch antenna 42 is added to the antenna element 22 having inferior performance, so that the branch antenna 42 can improve the signal receiving quality and the VSWR can be lower than 3. For example, as shown in FIG. 9, at m1 of frequency 470 MHz (X is 0.47), the VSWR is less than 2 (Y is 1.78); while at m2 of frequency 870 MHz (X is 0.87), the VSWR is less than 2 (Y is 1.95). From the above, it can be known that, the frequency range from m1 to m2 has good signal receiving quality, thus it can improve performance of frequency interval having inferior performance, to obtain wide bandwidth and good signal receiving quality. Of course, for each antenna element 22, a branch antenna element 42 may be added, to make the antenna module 20 have wide bandwidths and good signal receiving quality. Wherein, the geometric pattern of the branch antenna element 42 can be realized by using a conduction trace to connect to one of the antenna elements 22, and then to wind from outside toward inside to form a spiral shape.

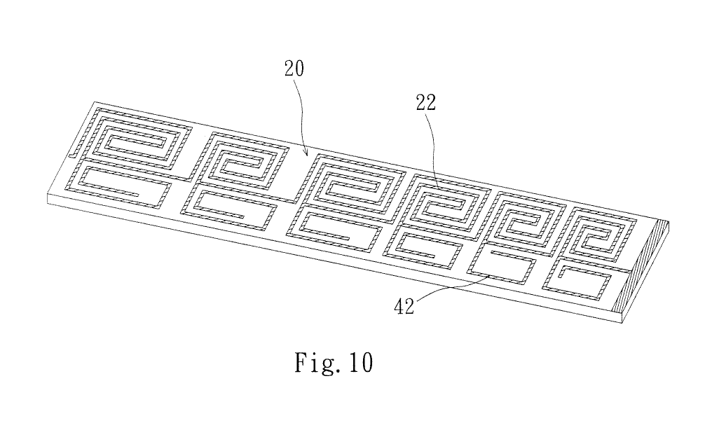

Then, refer to FIG. 10 for a schematic diagram of a wide bandwidth antenna according to an eighth embodiment of the present invention. As shown in FIG. 10, the difference between the present embodiment and the seventh embodiment is that, size of each of the antenna elements 22 can be different, thus the number of loops of spiral, spacing, width of the trace, geometric shape of the spiral, and size of each antenna element 22 can be adjusted based on actual requirement. Of course, the design of the number of loops of spiral, spacing, width of the trace, geometric shape of the spiral, and size of the branch antenna element 42 can be varied based on the need of the resonance frequency of the antenna element 22.

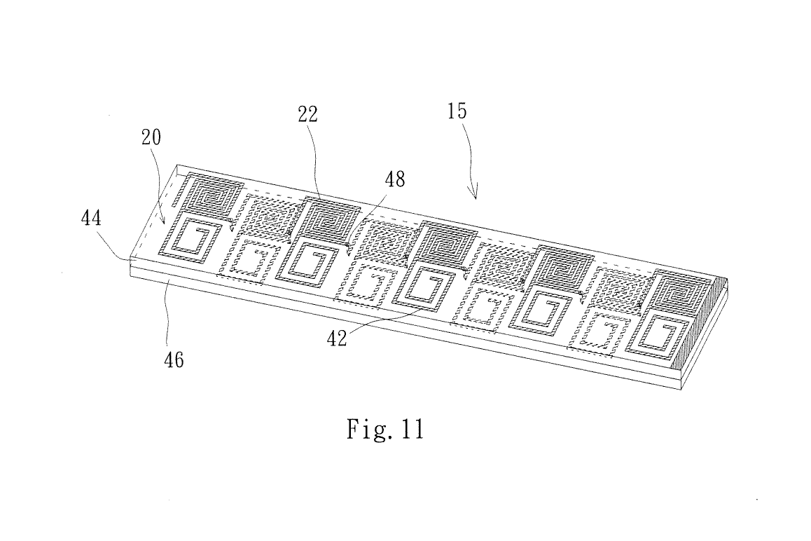

Subsequently, refer to FIG. 11 for a schematic diagram of a wide bandwidth antenna according to a ninth embodiment of the present invention. As shown in FIG. 11, the difference between the present embodiment and the seventh embodiment is that, the substrate used in the ninth embodiment is a multi-layer substrate, such as multilayer printed circuit board (PCB) or multilayer ceramic substrate, herein, two layer substrate is taken as example for explanation. As shown in FIG. 11, a wide bandwidth antenna 15 comprises a two layer substrate which has a first layer 44 and a second layer 46 under the first layer, each layer is provided with a plurality of antenna elements 22 thereon. The antenna elements 22 may each be selectively connected to a branch antenna element 42. Wherein, antenna elements 22 on the first layer 44 can be connected to antenna elements 22 on the second layer 46 through a plurality of through holes 48, to realize antenna elements 22 established on different layers of the multilayer substrates and all the antenna elements are connected one by one in series to form a wide bandwidth antenna. The first antenna element 22 is connected to signal input terminal for input and output of wireless signals.

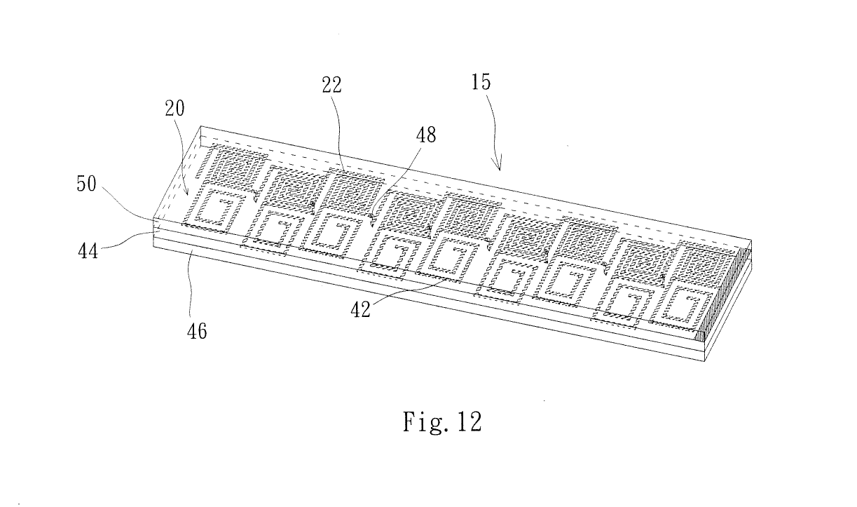

Continuing from the antenna structure presented in the ninth embodiment, refer to FIG. 12 for a schematic diagram of a wide bandwidth antenna according to a tenth embodiment of the present invention. As shown in FIG. 12, the wide bandwidth antenna 15 further includes a third substrate layer 50, disposed on the first substrate layer 44. Since a plurality of antenna elements 22 are established separately on the upper surfaces of the first substrate layer 44 and the second substrate layer 46, therefore, after placing the third substrate layer 50 on the first substrate layer 44, the antenna elements 22 are located between the third substrate layer 50 and the first substrate layer 44, and between the first substrate layer 44 and the second substrate layer 46, thus realizing the configuration of a plurality of antenna elements 22 established between three substrate layers of a multilayer substrate.

From the descriptions of the ninth and tenth embodiments and continue to increase the number of layer of the multilayer substrate, it can be known that, in the present invention, a plurality of antenna elements 22 can be disposed onto the surfaces of a plurality of stacked-up layers of a multilayer substrate and all the antenna elements are connected one by one serially hereby realizing a wide bandwidth antenna established on multi-layer substrate. As such, through adjusting dimension, shape, width of traces and spacings between traces of the antenna elements 22 on various substrate layers, antenna elements 22 of different characteristics can be produced, thus the bandwidth of an antenna can be effectively increased. In the present embodiment, a plurality of antenna elements and a multilayer substrate are used in explaining the implementation of the wide bandwidth antenna, however, the present invention should not be limited to this.

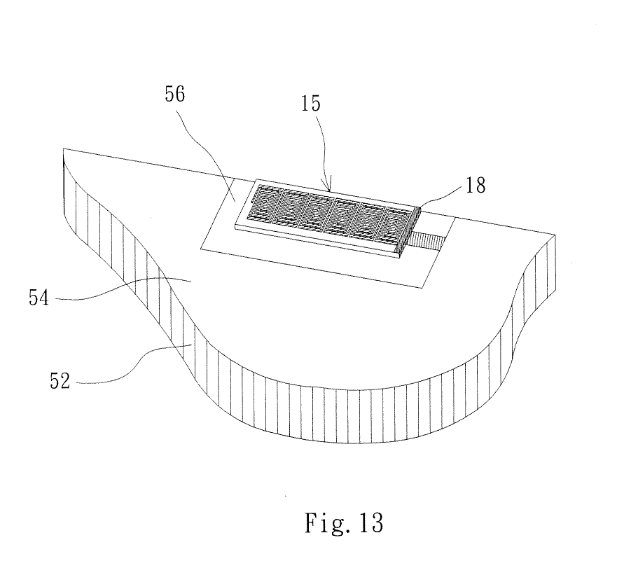

Furthermore, a wide bandwidth antenna 15 can be integrated on a circuit board. Refer to FIG. 13 for a schematic diagram of a wide bandwidth antenna according to an eleventh embodiment of the present invention. As shown in FIG. 13, on a circuit board 52 is provided with a circuit unit 54 and a keep-out area 56. Wherein, the circuit unit 54 is an electronic circuit obtained through plating or etching a metal layer of Cu, Sn, Ag, Au, or through thick film or thin film processes, and the electronic components are mounted onto the electronic circuit, to provide various electronic functions as required. Also, in order to avoid the interference of electronic circuit on the performance of antenna, a keep-out area 56 having no electronic circuitry is reserved on circuit board 52, such that the wide bandwidth antenna 15 can be installed in the keep-out. The signal input terminal 18 on the wide bandwidth antenna 15 is connected to the circuit unit 54 for receiving and transmitting wireless signals as required.

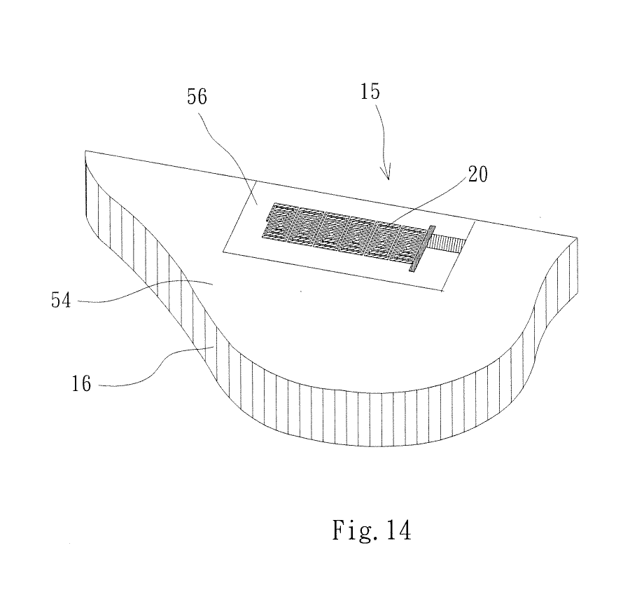

In addition to mounting a wide bandwidth antenna 15 onto a circuit board, also refer to FIG. 14 for a schematic diagram of a wide bandwidth antenna according to a twelfth embodiment of the present invention. As shown in FIG. 14, the wide bandwidth antenna 15 is disposed directly on a circuit board 16 serving as a substrate (refer to FIG. 2), that is an extended application of the first embodiment. Wherein, the substrate 16 can be a printed-circuit-board (PCB) or a printed-wiring-board (PWB) or a flexible printed-circuit-board (FPCB) well known in the industries, or a ceramic-based thick film or thin film circuit board, and of course other circuit boards that can carry and connect electronic elements also fall in the scope of the present invention. On the substrate 16 an electronic circuit is disposed, that is provided with a plurality of electronic elements to form a functional electronic unit 54. On the substrate 16, a keep-out area 56 where no electronic circuits or components are allowed is further provided for reducing electro-magnetic interference (EMI), such that the antenna module 20 can be disposed in the keep-out area 56, to improve the performance of antenna.

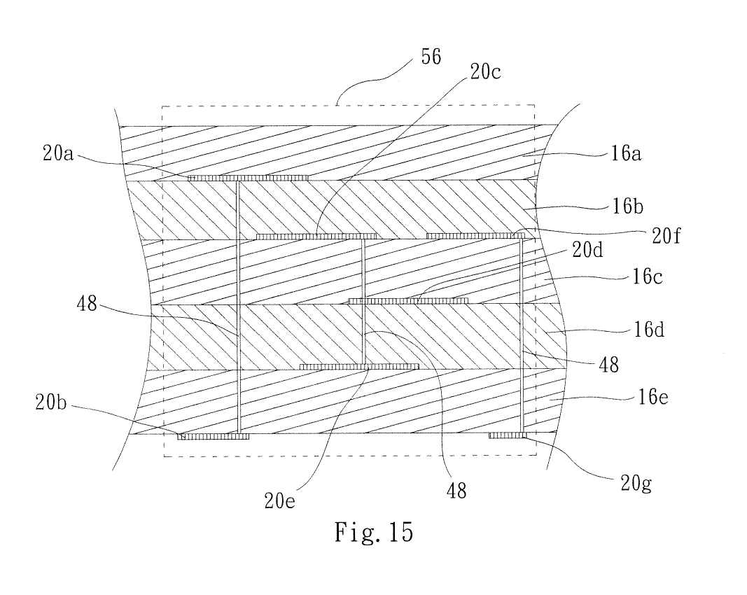

In addition to disposing antenna module directly on the surface of a substrate as mentioned in the twelfth embodiment, refer to FIG. 15 for an example of wide bandwidth antenna established on a multilayer substrate, wherein, the antenna elements of the wide bandwidth antenna module are disposed separately on the surfaces of the respective substrate layers, shown as the inter-layer surfaces in a stacked-up multilayer substrates. As shown in FIG. 15, the wide bandwidth antenna is provided with a circuit board that utilizes a stacked-up multilayer substrate containing a plurality of substrate layers, such as the stacked-up substrate layers 16a to 16e. The wide bandwidth antenna further includes a plurality of antenna elements 20a to 20g, disposed in the keep-out areas 56 of the respective substrate layers 16a to 16e, such that these substrate layers and antenna elements can be put together to form a wide bandwidth antenna wherein a plurality of antenna elements are connected one by one in a series. For example, antenna element 20a is disposed in the keep-out area 56 on the upper surface of substrate layer 16b, and that is connected to antenna element 20b via the through hole 48 penetrating through substrate layers 16b, 16c, 16d, and 16e, and the antenna element 20b is disposed in the keep-out area 56 on the lower surface of substrate layer 16e; antenna elements 20c, 20d, and 20e are disposed in the keep-out areas 56 on the upper surfaces of substrate layers 16c, 16d, and 16e, and antenna elements 20c, 20d, and 20e are connected electrically one by one via through hole 48; and antenna element 20f is disposed in the keep-out area 56 on the upper surface of substrate layer 16c, and it is connected to antenna element 20g via through hole 48, and antenna element 20g is disposed in the keep-out areas 56 on the lower surfaces of substrate layer 16e. Naturally, the present invention is not limited to disposing antenna modules on the surfaces of multilayer substrates, all the designs concerning disposing antenna modules on the surface of a single layer substrate or on the surfaces and inter-layer surfaces of multilayer substrate are within the scope of the present invention.

Summing up above, in the present invention, spiral geometric patterns of a plurality of antenna elements are put together, such that the first antenna element defines the highest resonance frequency, then antenna elements are added in sequence, until it can produce the lowest resonance frequency required, thus the lowest resonance frequency is defined jointly by all the antenna elements. As such, the range of resonance frequency of the wide bandwidth antenna ranges from the highest resonance frequency to the lowest resonance frequency, hereby increasing resonance bandwidth in achieving a wide bandwidth antenna. Therefore, in the present invention, wide bandwidth antenna is achieved through different geometric patterns formed in a spiral approach, hereby having the advantages of changing frequency band of the antenna; increasing antenna bandwidth, improving quality of the received signal, and reducing size of antenna.

Moreover, according to the various embodiments mentioned above, and based on the implementation of antenna elements having various spiral geometric patterns, for a 470 MHz to 870 MHz wide bandwidth UHF antenna, the size of the entire antenna is only 3*0.45*0.22 cm. In contrast, for an antenna structure of the prior art, and for a 470 MHz antenna having circuit board of dielectric constant 4, its length is about 8 cm. Compared with the prior art antenna, the wide bandwidth antenna of the present invention does make remarkable progress and improvement. In the present invention, an embodiment of wide bandwidth antenna utilizing spiral type antenna elements and operating in a frequency range of 470-870 MHz is illustrated, however, this is only one of the preferred embodiments, and the present invention is not limited to this. The emphasis of the present invention is on achieving wide bandwidth through connecting one by one a plurality of antenna elements with spiral geometric patterns. The present invention is simple in structure, easy to manufacture, thin in profile, and compact in size, and it is therefore suitable for use in various electronic devices, and having a good competitive edge in the market.

The development of the wide bandwidth antenna of the present invention is in line with the present market trend of mobile device, which has the advantages of improving signal transmission and receiving quality, reducing further its size, and increasing flexibility and convenience in the application of electronic products.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include all various changes and equivalent arrangements which are all within the scope of the claims of the present invention.

What is claimed is:

1. A wide bandwidth antenna, which is connected to at least one signal line for transmitting and receiving wireless signals, comprising:
at least a substrate made of a dielectric material;
at least a signal input terminal provided on said substrate for the establishment of electrical connection with said signal line for signal input and output; and
at least an antenna module, disposed on said substrate, comprises a plurality of antenna elements with spiral geometric patterns, wherein said geometric pattern of the first said antenna element is formed by an electrically conductive spiral trace winds from the starting point at the outside of said geometric pattern toward inside, and then winds back again from inside toward outside, and
continuing from an end point of said geometric pattern of said first antenna element, the electrically conductive spiral trace of the second said antenna element winds from the outside of the geometric pattern toward inside, and then winds back from inside toward outside to form a second antenna element, continuing these procedures until the needed number of said antenna elements is established, and
said starting point of the spiral geometric pattern of said first antenna element is connected to said signal input terminal.

2. The wide bandwidth antenna as claimed in claim 1, wherein the length of said spiral trace, the width of the trace, the spacing between the traces, the number of loops of spiral and the geometric shape of the spiral determine a resonant frequency and a bandwidth of said antenna element and said antenna module.

3. The wide bandwidth antenna as claimed in claim 1, wherein said first antenna element in said antenna module defines the highest resonance frequency of said wide bandwidth antenna, and the lowest resonance frequency is formed jointly by all said antenna elements of said antenna module, and said wide bandwidth antenna can transmit/receive wireless signals ranging from said highest resonance frequency to said lowest resonance frequency.

4. The wide bandwidth antenna as claimed in claim 1, wherein total number of said antenna elements and length of said antenna module determine said bandwidth of said wide bandwidth antenna, said bandwidth of said wide bandwidth antenna increases when total number of said antenna elements is increased or length of said antenna module is increased or both are increased.

5. The wide bandwidth antenna as claimed in claim 1, wherein said geometric patterns of said antenna element is of a round spiral shape, a square spiral shape, a triangle spiral shape, a polygon spiral shape, or an irregular spiral shape.

6. The wide bandwidth antenna as claimed in claim 1, wherein said antenna module disposed on said dielectric substrate is formed by connecting same geometric pattern of spirals or various geometric patterns of spirals.

7. The wide bandwidth antenna as claimed in claim 1, wherein said resonant frequency of said antenna element is decreased and said bandwidth at said resonant frequency of said antenna element is increased by adding a side branch to said geometric pattern of said antenna element.

8. The wide bandwidth antenna as claimed in claim 7, wherein the geometric pattern of said side branch is of a round spiral shape, a square spiral shape, a triangle spiral shape, a polygon spiral shape, a irregular spiral shape, a serpentine shape, or a trace segment with various shapes.

9. The wide bandwidth antenna as claimed in claim 1, wherein said antenna elements of said antenna module are of different sizes, and are connected one by one in series.

10. The wide bandwidth antenna as claimed in claim 1, wherein at least a zigzag, a serpentine, or a trace segment of other shape is added between connected antenna elements.

11. The wide bandwidth antenna as claimed in claim 1, wherein said substrate is of a multilayer substrate, wherein said antenna elements are distributively disposed on various layers of said multilayer substrate, and are connected one by one through a plurality of through holes on said substrate to form electrical connections and produce said resonance frequency and bandwidth as required.

12. The wide bandwidth antenna as claimed in claim 1, wherein at least two said antenna modules are established parallelly on said substrate, and the starting points of the first said antenna elements of each said antenna modules are connected together and then connected to said signal input terminal.

13. The wide bandwidth antenna as claimed in claim 1, wherein each said antenna element comprises at least two sub-antenna elements disposed in parallel on said substrate, and the starting points of each said sub-antenna element are connected together, and the end points of each said sub-antenna element are connected together, and said antenna elements are then connected one by one in series, and the starting point of the first said antenna element is connected to said signal input terminal.

14. The wide bandwidth antenna as claimed in claim 1, wherein said substrate is of a multilayer substrate, wherein said antenna module is disposed on the internal layers of said multilayer substrate.

15. The wide bandwidth antenna as claimed in claim 1, wherein said substrate is made of a dielectric material which is plastic, glass, ceramic, magnetic material, or a composite of abovementioned materials.
